(19) United States
(12) Patent Application Publication
(10) Pub. No.: US 2019/0110507 A1
(43) Pub. Date: Apr. 18, 2019

(54) AGGLOMERATE BEVERAGE MODIFIER COMPRISING WHOLE GRAINS, METHOD OF PRODUCING THE AGGLOMERATE AND MILK-BASED BEVERAGE COMPRISING SAME

(71) Applicant: The Quaker Oats Company, Chicago, IL (US)

(72) Inventors: Luana Buso Jacon, Sorocaba (BR); Aline Caixeta Oliveros, Indaiatuba (BR); Vanessa Dias Alves, Sao Paulo (BR); Isa Monica Mota Sebrao, Itu (BR); Laura Maria Pires Blasi, Sao Paulo (BR); Natalia Sandonato, Buenos Aries (AR)

(21) Appl. No.: 15/787,361

(22) Filed: Oct. 18, 2017

(51) Int. Cl. A23L 7/10; A23L 19/00; A23L 29/20; A23L 29/30; A23L 2/52; A23G 1/00; A23P 10/22; A23C 9/13; A21D 6/00

(52) U.S. Cl. CPC A23L 7/197; A23L 7/198; A23L 19/00; A23L 29/20; A23L 29/37; A23L 2/52; A23V 2250/5034; A23P 10/22; A23C 9/1315; A21D 6/006; A23V 2002/00; A23V 2250/1842; A23G 1/00

(57) ABSTRACT

An agglomerate product comprises a significant percentage of whole grain materials. A whole grain dry component comprising its native starch form is agglomerated with other dry components to provide agglomerates that are highly dispersible agglomerates, which comprise a dry blend substantially comprising whole grains. The agglomerates can be added to modify beverages such as milk products to produce a ready-to-drink beverage that provides a minimum of about ½ to 1 serving of whole grains per 8-ounce serving.

### BACKGROUND OF THE INVENTION

### Technical Field

The present invention relates to a dispersible agglomerated powder comprising a high percentage of whole grains for incorporating into beverages.

### Description of Related Art

Many consumers would benefit from beverage products having desirable tastes and low cholesterol. There is also need and desire for quick and convenient ready-to-drink beverages that produce various tastes while increasing the quality of beverages. Preparation should include little effort to obtain a drinking experience that provides the benefits of adding whole grains and other beneficial nutrients to the diet with a pleasant aftertaste. The modification should be possible for any beverage at any temperature and the product should be shelf stable and easy to use.

### SUMMARY OF THE INVENTION

Provided herein is are agglomerates for quick and convenient addition to beverage products to provide for an enhanced drinking experience, including, for example, convenient introduction of beneficial nutrients together with good mouthfeel and creamier taste. More specifically, an agglomerate powder material comprising significant amounts of whole grain provides for balanced flavors while delivering a good source of oats to the consumer in a liquid formulation or beverage. Further description of the agglomerate will become apparent in the below written detailed description.

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

Agglomerates described herein comprise between about 20% to about 80% substantially non-gelatinized, non-hydrolyzed whole grains, up to about 40% dried fruit; between about 0.5% to about 2% hydrocolloids, up to about 12.5% fiber; up to about 3.75% beta-glucan; up to about 45% sweetening component, up to about 2% lecithin; and up to about 25% cocoa, the agglomerates comprising a moisture content of up to about 7%. The agglomerates further comprise between about 70% to about 90% particles sized from between about 100 to about 1,000 μm. In any embodiment, the agglomerates comprise a minimum of about 20% non-hydrolyzed whole grains. In any embodiment, the agglomerates comprise a wettability of up to about 300 seconds. In any embodiment, the whole grain comprises any suitable cereal grain such as oat, wheat, corn (maize), rice, barley, rye, quinoa, sorghum, millet, triticale, linseed, chia or combination thereof.

Other aspects, embodiments and features of the invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts the wettability of various sample agglomerate embodiments described herein, which produced desirable chocolate flavored milk beverage products.

FIG. 2 depicts the wettability of various sample agglomerate embodiments described herein, which produced desirable vanilla flavored milk beverage products.

FIG. 3 depicts an agglomeration process.

### DETAILED DESCRIPTION OF THE INVENTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified together with the phrase. The term “consisting essentially of” limits the scope of a claim to the specified elements, steps or material(s) and those that do not materially affect the basic and novel characteristic(s) of the claimed invention. As used herein, “up to” includes zero, meaning no amount is added in some embodiments.

It should be understood that, where context allows, the term “amount” is used interchangeably with “concentration.” As used here, these terms should be understood to mean the amount of the component in question by weight of the total product composition or final beverage formulation, unless otherwise stated. As used herein, the phrase “weight percent” refers to a weight percent calculated based on the total weight of a given composition or formulation. Several embodiments for the dispersible agglomerates and methods for making the agglomerates will now be described.

Agglomerates described herein are dispersible dry powders composed of fine particles that serve as a dry powdered beverage modifier with a high percentage of whole grains, which can be easily prepared with cold or hot fluids with gentle spoon stirring by a consumer. The agglomerates are shelf stable, comprising a moisture content of up to about 7%. In some embodiments, the agglomerates comprise a moisture content of up to about 6%. In some embodiments, the agglomerates comprise a moisture content of up to about 5%. In some embodiments, the agglomerates comprise a moisture content of up to about 4%. In some embodiments, the agglomerates comprise a moisture content of not less than about 3%. In some embodiments, the agglomerates comprise a moisture content of between about 3.5% to about 7%.

Upon addition of the agglomerates into a beverage with spoon stirring, an improved beverage having desirable taste and consistency is obtained. Beverages prepared using agglomerates described herein provide ½ to 1 serving of whole grain oats per 8-oz serving. Suitable beverage products to which the agglomerates may be added include, for example, juice beverages (e.g., beverages comprising one or more fruit juices and/or one or more vegetable juices), hydration beverages such as those with added electrolytes, sports drinks, flavored waters, frozen or chilled beverages, caffeinated beverages, carbonated beverages, non-carbonated beverages, and zero to low calorie drinks (for example, 0-150 kcals and up to 10 grams sugar/12 oz.), such as diet or other reduced calorie beverages. In certain embodiments, the beverage product can be any non-carbonated soft drinks, fountain beverages, refrigerated ready-to-drink beverages, coffee, tea, and other brewed beverages, dairy beverages, enhanced waters, fruit juice such as orange juice (including diluted and ready to drink concentrated juices), fruit juice-flavored drinks, smoothies and semi-solids beverages such as liquid yogurt. In particular embodiments, the agglomerates are added to dairy beverage products such as milk or smoothies, for example. In some embodiments, an improved beverage comprising the agglomerates described herein comprises dairy. In some embodiments, the improved beverage comprises a milk beverage product. In some embodiments, the improved beverages comprise a smoothie product. In some embodiments, a serving size comprises up to 20 grams of the whole grain agglomerates in 160 mL of a beverage. In some embodiments, the agglomerates provide for between about 10 grams to about 14 grams of whole grains per 240 mL serving.

Agglomerate formulations described herein provide for rapid liquid penetration into the powder agglomerates, rapid sinking below the liquid surface, and easy dispersion in the liquid. These properties are achieved through the use of agglomeration technology, by which the particle size of selected dry components is increased through the binding together of the dry components. The agglomerated dry components described herein provides for a high amount of whole grains with the ability to disperse into a liquid with minimal sedimentation in a ready-to-drink final beverage. The term “ready-to-drink” refers to a beverage formulated to be ingested as-is. Thus, the ready-to-drink beverage requires no dilution or additions prior to ingestion by a consumer. In addition to dispersability, the agglomerates deliver less sugar than agglomerates having no or significantly lower amounts of whole grains. The components of the agglomerates described herein provides for desirable vitamins and improved intestinal tract transit time and heart health through the reduction of LDL cholesterol levels.

Generally, the agglomerates described herein comprise non-hydrolyzed, substantially non-gelatinized whole grains in an amount of up to about 80% (e.g., about 5%, about 10%, about 15%, about 20%, about 25%, about 30%, about 35%, about 40%, about 45%, about 50%, about 55%, about 60%, about 65%, about 70%, about 75%, about 80%, or any ranges between these recited percentages). In some embodiments, agglomerates comprise between about 5% to about 80% non-hydrolyzed, substantially non-gelatinized whole grains. In some embodiments, the agglomerates comprise at least about 20% non-hydrolyzed, substantially non-gelatinized whole grains. In some embodiments, agglomerates comprise between about 20% to about 80% non-hydrolyzed, substantially non-gelatinized whole grains. In some embodiments, agglomerates comprise between about 20% to about 70% non-hydrolyzed, substantially non-gelatinized whole grains. In some embodiments, agglomerates comprise between about 29% to about 80% non-hydrolyzed, substantially non-gelatinized whole grains. In some embodiments, the agglomerates comprise between about 35% and about 65% non-hydrolyzed, substantially non-gelatinized whole grains. In some embodiments, the agglomerates comprise between about 40% and about 60% non-hydrolyzed, substantially non-gelatinized whole grains. In some embodiments, agglomerates comprise between about 40% to about 50% non-hydrolyzed, substantially non-gelatinized whole grains.

As used herein, “non-hydrolyzed, substantially non-gelatinized whole grain” refers to a whole grain that is both free of hydrolyzed starch (i.e., 0% hydrolyzed starch) and also substantially non-gelatinized (i.e., no more than about 20% gelatinized and at least about 80% ungelatinized). Thus, there are no starch changes or modifications to the whole grain component, which remains in its native starch structure, and the whole grain component also comprises minimal gelatinization in an amount of no more than about 20%.

Suitable whole grains are dry cereal components comprising whole grains, including without limitation oat, wheat corn (maize), rice, barley, millet, sorghum, rye, triticale, amaranth, quinoa, linseed, chia, or any combination thereof. The whole grains comprise dry components derived from such cereal grains, including without limitation flours, powder, granules, and flakes. In certain embodiments, the whole grain comprises oat flour, wheat corn flour, rice flour, barley flour, millet flour, sorghum flour, rye flour, triticale flour, amaranth flour, quinoa flour, linseed flour, chia flour, or any combination thereof. In certain embodiments, the whole grain comprises oat powder, wheat corn powder, rice powder, barley powder, millet powder, sorghum powder, rye powder, triticale powder, amaranth powder, quinoa powder, linseed powder, chia powder, or any combination thereof. In certain embodiments, the whole grain consists of dry components derived from oats. In certain embodiments, the whole grain consists of dry components derived from wheat corn (maize). In certain embodiments, the whole grain consists of dry components derived from rice. In certain embodiments, the whole grain consists of dry components derived from barley. In certain embodiments, the whole grain consists of dry components derived from millet. In certain embodiments, the whole grain consists of dry components derived from sorghum. In certain embodiments, the whole grain consists of dry components derived from rye. In certain embodiments, the whole grain consists of dry components derived from triticale. In certain embodiments, the whole grain consists of dry components derived from amaranth. In certain embodiments, the whole grain consists of dry components derived from quinoa. In certain embodiments, the whole grain consists of dry components derived from linseed. In certain embodiments, the whole grain consists of dry components derived from chia. Suitable whole grains are readily available from any number of manufacturers.

Prior to agglomeration, components of the agglomerates should comprise a particle size of no more than about 200 μm. Thus, in some embodiments, dry components may comprise milled components to achieve the proper fine size for agglomeration. Following agglomeration, between about 70% to about 90% of the agglomerates comprise a particle size of between about 100 to about 1,000 μm. In some embodiments, the dry components of the agglomerates comprise a median size of about 190 μm. In some embodiments, the dry components of the agglomerates comprise a range of between about 60 to about 200 μm. Minor amounts (i.e., <3%) of liquid may also be added to the agglomerate in some embodiments.

Agglomerates further comprise sufficient dry fruit components to achieve up to 40 grams of fresh fruit per 160 mL beverage serving. The percentage may vary, depending on the fruit used. Suitable dry fruit components comprise powders, flakes, flours, and any combination thereof so long as the above sizes are achieved. In some embodiments, the agglomerates are free of dry fruit particles or components (e.g. 0%). In some embodiments, the agglomerates comprise between about 1% to about 40% dry fruit (e.g., about 1%, about 2.5%, about 5%, about 7.5%, about 10%, about 12.5%, about 15%, about 17.5%, about 20%, about 22.5%, about 25%, about 27.5%, about 30%, about 32.5%, about 35%, about 37.5%, about 40%, or any ranges between these recited percentages). In some embodiments, the agglomerates comprise between about 1% to about 30% dry fruit. In some embodiments, the agglomerates comprise between about 1% to about 25% dry fruit. In some embodiments, the agglomerates comprise between about 1% to about 15% dry fruit. In some embodiments, the dry fruit comprises fruit powder. By way of example, and without intending to limit the scope, suitable dry fruit components dried powders, flakes, and/or granules derived from any number of fruits, including without limitation apple, banana, papaya, guava, litchi, coconut, strawberry, blueberry, raspberry, blackberry, melon, watermelon, pear, apricot, orange, lime, lemon, grapefruit, tangerine, mandarin orange, tangelo, pomelo, grape, cherry, pineapple and any combination thereof. Suitable dry fruit components are readily available from any number of manufacturers.

The agglomerates further comprise between about 0.01% to about 2% hydrocolloids. In some embodiments, the agglomerates further comprise between about 0.5% to about 2% hydrocolloids. In some embodiments, the agglomerates further comprise between about 1% to about 2% hydrocolloids. Suitable hydrocolloids comprise powders, flakes, flours and any combination thereof. Suitable hydrocolloids are readily available from any number of manufacturers. In some embodiments, the hydrocolloid comprises xanthan gum, carrageen gum, carboxymethyl cellulose, guar gum, gellan gum, locust bean gum, and any combination thereof. In some embodiments, the hydrocolloid consists of one or more of xanthan gum, carrageen gum, CMC, guar gum, gellan gum, locust bean gum, and any combination thereof.

The agglomerates further comprise sufficient fiber to achieve about 2.5 grams of fiber per 160 mL portion. Suitable fiber components comprise powders, flakes, flours, and any combination thereof. In some embodiments, the agglomerates comprise up to about 12.5% fiber (e.g., about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, or any ranges between these recited percentages). In some embodiments, the agglomerates comprise a minimum of about 2% fiber. In some embodiments, the agglomerates comprise between about 2% to about 12.5% fiber. In some embodiments, the agglomerates comprise between about 4% to about 11% fiber. In some embodiments, the agglomerates comprise between about 7% to about 10% fiber. By way of example, fibers within the agglomerates as described herein comprise both natural fibers (rice, oat, wheat, corn, etc.) and isolated fibers including without limitation fructooligosaccharides, inulin, resistant starch, resistant maltodextrin, polydextrose, and any combination thereof. Suitable fiber components as described above are readily available from any number of manufacturers.

The agglomerates further comprise up to about 3.75% beta-glucan fiber (e.g., about 0.75%, about 1%, about 1.25%, about 1.5%, about 1.75%, about 2%, about 2.25%, about 3.5%, about 3.75%, or any ranges between these recited percentages). In some embodiments, the beta-glucan is an isolated beta-glucan. In some embodiments, the agglomerates comprise a minimum amount of at least about 0.75% beta-glucan fiber. In some embodiments, the agglomerates comprise between about 0.75% to about 3.75% beta-glucan fiber. In some embodiments, the agglomerates comprise between about 1% to about 3% beta-glucan fiber. In some embodiments, the agglomerates comprise between about 1.25% to about 2.5% beta-glucan fiber. In some embodiments, the agglomerates comprise sufficient beta-glucan to achieve 750 mg of beta-glucan fiber per beverage serving. In some embodiments, the beta-glucan fiber is at least partly derived from oats, including without limitation oat bran and whole oat flour. In some embodiments, the beta-glucan fiber is only partly derived from oats. In some embodiments, the beta-glucan fiber comprises an isolated form of beta-glucan added to the dry components, which are subsequently agglomerated. Suitable beta-glucan fiber is readily available from any number of manufacturers.

The agglomerates also comprise up to about 45% sweetening component (e.g., 0%, about 5%, about 10%, about 15%, about 20%, about 25%, about 30%, about 35%, about 40%, about 45%, or any ranges between these recited concentrations). When present, the sweetening component can be nutritive or non-nutritive, natural or synthetic sweetener, or a combination of such sweeteners, so long as the sweetener(s) provides a taste that is perceived as sweet by the sense of taste. The perception of flavoring agents and sweetening agents can depend to some extent on the interrelation of elements. Flavor and sweetness can also be perceived separately, i.e., flavor and sweetness perception can be both dependent upon each other and independent of each other. For example, when a large amount of a flavoring agent is used, a small amount of a sweetening agent can be readily perceptible and vice versa. Thus, the oral and olfactory interaction between a flavoring agent and a sweetening agent can involve the interrelationship of elements. When used to sweeten, the sweetening component is present in the agglomerate in an amount above the sweeteners' sweetness recognition threshold concentration. The term “sweetness recognition threshold concentration,” as generally used herein, is the lowest known concentration of a given sweetener or combination of sweeteners that is perceivable by the human sense of taste, typically around about 1.5% sucrose equivalence. As used herein, “taste” refers to a combination of sweetness perception, temporal effects of sweetness perception, i.e., on-set and duration, off-tastes, e.g. bitterness and metallic taste, residual perception (aftertaste), and tactile perception, e.g. body and thickness.

In some embodiments, the sweetening component comprises a nutritive sweetener. The term “nutritive sweetener” refers generally to sweeteners which provide significant caloric content in typical usage amounts, e.g., more than about 5 calories per 8 oz. serving of a beverage. In some embodiments, the nutritive sweetener is sucrose, glucose, fructose, or any combination thereof. In some embodiments, the nutritive sweetener is high fructose corn syrup, honey granules, or sugar. In some embodiments, the nutritive sweetener comprises a powder format. In some embodiments, the sweetening component consists of a powder.

By way of example, the term “sugar” includes natural cane sugar made from sugar cane and/or granulated sugar made from either cane or sugar beets. Some embodiments of the agglomerate may comprise 0% sugar. In other embodiments, the agglomerates comprise a minimum of about 10% sugar. In some embodiments, the agglomerates comprise between about 10% to about 45% sweetening component. In some embodiments, the agglomerates comprise between about 20% to about 40% sweetening component. In some embodiments, the sweetening component consists of a nutritive sweetener. In some embodiments, agglomerates provide for less than about 5 grams sugar per 100 mL serving.

In some embodiments, the sweetening component comprises a non-nutritive sweetener. As used herein, the term “non-nutritive sweetener” refers to all sweeteners other than nutritive sweeteners. In some embodiments, the non-nutritive sweetener is a natural non-nutritive sweetener selected from the group consisting of rebaudioside A, rebaudioside B, rebaudioside C, rebaudioside D, rebaudioside M, iso-steviol glycosides, mogrosides, trilobatin, and combinations thereof. In some embodiments, the non-nutritive sweetener is rebaudioside A (Reb A), rebaudioside D (Reb D), rebaudioside M (Reb M), or any combination thereof (e.g., a mixture of Reb A and Reb D, a mixture of Reb D and Reb M, or a mixture of Reb A, Reb D, and Reb M). In some embodiments, the non-nutritive sweetener comprises a stevia leaf blend. In some embodiments, the non-nutritive sweetener comprises maltodextrin. In some embodiments, the low-calorie beverage comprises an artificial sweetener such as aspartame, sucralose, acesulfame potassium (ASK), or any combination thereof. In some embodiments, the agglomerates comprise between about 0.05 to about 0.3% non-nutritive sweetener. In some embodiments agglomerates comprise between about 0.03% to about 0.15% non-nutritive sweetener. In some embodiments, agglomerates comprise between about 0.05% to about 0.225% non-nutritive sweetener. In some embodiments, the agglomerates comprise between about 0.05% to about 40% non-nutritive sweetener.

In some embodiments, the sweetening component comprises a nutritive sweetener and a non-nutritive sweetener. In some embodiments, the sweetening component comprises a combination of one or more natural nutritive sweeteners, one or more artificial sweeteners, and/or one or more natural non-nutritive sweeteners. Suitable forms of non-nutritive and nutritive sweeteners are readily available from any number of manufacturers. Exemplary natural nutritive sweeteners suitable for use in the agglomerates herein include crystalline or liquid sucrose, fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses, and sugar beet molasses; sorghum syrup, and mixtures thereof.

Other sweeteners suitable for use in the agglomerates described herein include, but are not limited to, sugar alcohols such as erythritol, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, and mixtures thereof.

Other sweeteners suitable for use in the agglomerates described herein include rare sugars such as D-allose, D-psicose (also known as D-allulose), L-ribose, D-tagatose, L-glucose, L-fucose, L-arabinose, D-turanose, D-leucrose, and mixtures thereof.

Exemplary artificial sweeteners suitable for use in the agglomerate described herein include, but are not limited to, saccharin, cyclamate, aspartame, neotame, advantame, acesulfame potassium, sucralose, mixtures thereof.

Exemplary natural non-nutritive potent sweeteners suitable for use in the agglomerates described herein include steviol glycosides (e.g., stevioside, steviolbioside, rebaudioside A, rebaudioside B, rebaudioside C, rebaudioside D, rebaudioside E, rebaudioside F, rebaudioside H, rebaudioside I, rebaudioside N, rebaudioside K, rebaudioside J, rebaudioside O, rebaudioside M, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, mabinlins I and II, and mixtures thereof.

In other embodiments, sweeteners derived from fruit, such as Lo Han Guo (LHG) juice concentrate, can be used as a nutritive sweetener in the agglomerates described herein. Other natural non-nutritive potent sweeteners, as described above or any mixture of any of those, can also be included in the agglomerate. LHG may be obtained from fruit of the plant family Cucurbitaceae, tribe Jollifieae, subtribe Thladianthinae, genus Siraitia. LHG often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Luo Han fruit. LHG contains triterpene glycosides or mogrosides, which constituents may be used as LHG sweeteners. LHG may be used as the juice or juice concentrate, powder, etc. LHG juice concentrate may contain about 3 wt. % to about 12 wt. %, e.g., about 6 wt. % mogrosides, such as mogroside V, mogroside IV, (11-oxo-mogroside V), siamenoside and mixtures thereof. LHG may be produced, for example, as discussed in U.S. Pat. No. 5,411,755. Sweeteners from other fruits, vegetables or plants also may be used as natural or processed sweeteners or sweetness enhancers in at least certain exemplary embodiments of the agglomerate products disclosed here.

The agglomerates described herein also comprise up to about 2% lecithin. In some embodiments, the agglomerates are free of lecithin. In some embodiments, the agglomerates comprise between about 0.5% lecithin to about 2% lecithin (e.g., about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, or any ranges between these recited concentrations). Suitable forms of lecithin are readily available from any number of manufacturers.

Agglomerates further comprise up to about 25% cocoa. In some embodiments, the agglomerates are free of cocoa. In some embodiments, the agglomerates comprise between about 5% cocoa to about 25% cocoa (e.g., about 5%, about 7.5%, about 10%, about 12.5%, about 15%, about 17.5%, about 20%, about 22.5%, about 25%, or any ranges between these recited concentrations). Embodiments comprising cocoa may comprise from between about 0.5% lecithin to about 2% lecithin, or any range or lecithin described above, so long as some amount of lecithin is present. In some embodiments, the agglomerates comprise between about 8% to about 20% cocoa. In some embodiments, the agglomerates comprise between about 10% to about 15% cocoa. Suitable forms of cocoa are readily available from any number of manufacturers.

The agglomerate products disclosed here may comprise both mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% Recommended Daily Value (RDV), where such RDVs are established. In certain exemplary embodiments, the non-mineral nutritional supplement ingredient(s) can be present in an amount of from about 5% to about 30% RDV, where established.

As used herein, “wettability” refers to the measure of time required for the agglomerate particles to sink below a liquid surface, caused by the liquid penetration into the powdered system of the agglomerates with no stirring at all. The agglomerates described herein comprise a wettability of no more than about 300 seconds. In some embodiments, the agglomerates comprise a wettability of no more than about 250 seconds. In some embodiments, the agglomerates comprise a wettability of no more than about 200 seconds. In some embodiments, the agglomerates comprise a wettability of no more than about 100 seconds. In some embodiments, the agglomerates comprise a wettability of no more than about 75 seconds. In some embodiments, the agglomerates comprise a wettability of between about 2 seconds to about 300 seconds. In some embodiments, the agglomerates comprise a wettability of between about 50 seconds to about 250 seconds. In some embodiments, the agglomerates comprise a wettability of between about 100 seconds to about 200 seconds. In some embodiments, the agglomerates comprise a wettability of less than about 10 seconds.

The agglomerates described herein generally comprise a bulk density of between about 0.3 g/mL to about 0.60 g/mL. In some embodiments, the agglomerates comprise a bulk density of between about 0.4 to about 0.55 g/L. Agglomerates described herein are free of refined cereal flour, nut flour, and vegetable oil. In some embodiments, the agglomerates are free of sodium chloride.

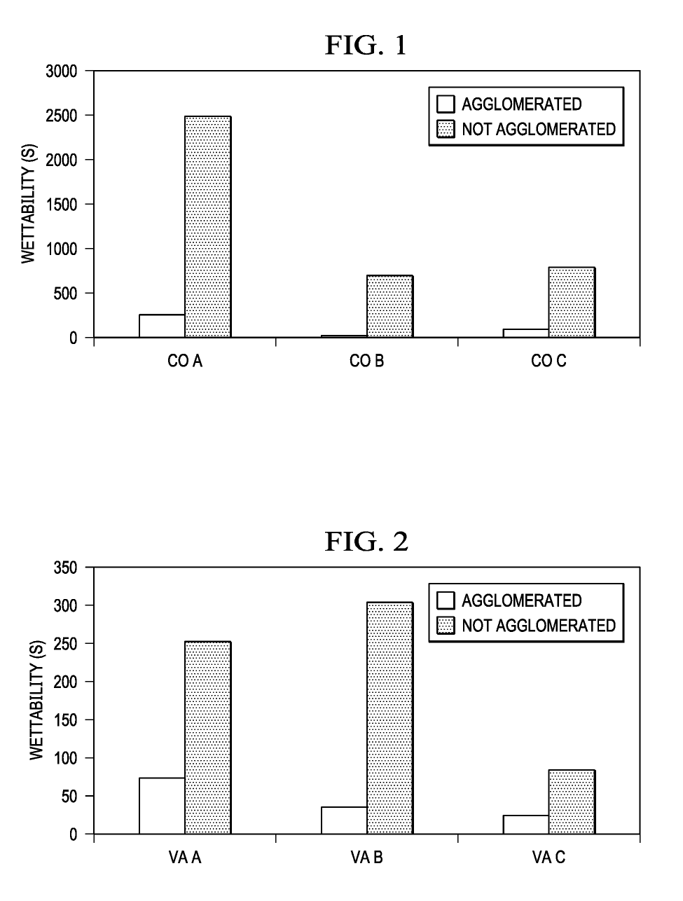

FIGS. 1 and 2 depict wettability times for a number of samples tested. Various embodiments of agglomerated particles as described above were compared against their non-agglomerated sample components. FIG. 1 depicts various vanilla flavored beverage embodiments, while FIG. 2 depicts samples providing for a chocolate flavored beverage embodiments. All samples shown in the figures were tested using a range of milk products. It can be seen that non-agglomerated samples took more time to wet and sink the particles in water than the agglomerates. By way of comparison, non-agglomerated cocoa formulations comprised a wettability of up between about 600 to about 2500 seconds during test runs, whereas agglomerated versions of similar formulations comprised a wettability of less than about 250 seconds. Similar comparisons with non-agglomerated vanilla formulas comprised a wettability of about 240 seconds to about nearly 300 seconds, whereas agglomerated versions of similar formulations comprised a wettability of less than about 75 seconds. This same pattern of significantly less wettability for agglomerated formulations was observed for fruit formulas (non-agglomerated wettability of over 60 seconds vs. agglomerated versions comprising a wettability of less than 5 seconds). Due to the pore structure and water affinity of the agglomerated samples, the agglomerates sink faster and comprise better wettability and dispersion. Sensory evaluation indicated that agglomerated samples presented less mouthfeel and higher perception of flavors than counterpart non-agglomerated samples.

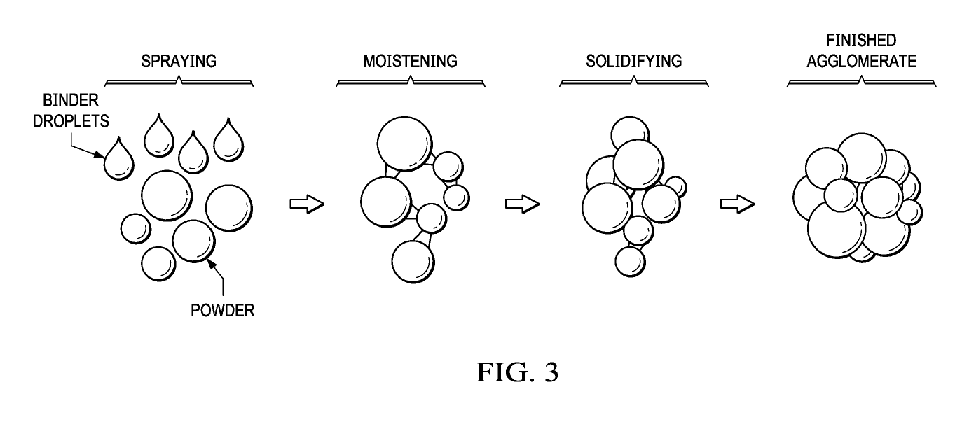

Agglomeration refers to the process by which the particle size of a material is increased through the binding of particles together, with the resulting aggregates having new physical properties. FIG. 3 depicts the general agglomeration process used in producing the agglomerates described herein. Generally, small particles as described herein (comprising up to about 200 μm) are sprayed with binder droplets to moisten the particles and thereby form liquid bridges between the particles. Drying processes ensure solidifying of the particles into a “snowball” structure to produce a substantially spherical shape. The term “substantially spherical” as it relates to the agglomerates described herein means solid particles bound together with a high degree of sphericity while achieving porosity to enable the liquid flow into the granule due to capillary forces improving wettability and dispersability properties of the agglomerated powder.

The method of making the agglomerates comprises the steps of forming a dry blend comprising dry components, wherein the dry components comprise non-hydrolyzed, substantially non-gelatinized whole grains; and agglomerating the dry blend to form agglomerates comprising whole grains. The forming of the dry blend comprises the mixing of the dry components including suitable whole grains as described above. Mixing of the dry components should take place until a homogenous mix of dry blend components is achieved. Any number of mixing options are readily available and known to those skilled in the art. In some embodiments, the dry components may be added to a dry blender for mixing. In one embodiment, mixing is performed for between about 8 to about 20 minutes. In one embodiment, the mixing is performed at between about 6000 to about 15000 rpm, depending on mixer design.

For embodiments comprising lecithin, the method comprises a separate step for lecithin application. In some embodiments, the method comprises a step of adding lecithin onto the dry blend (i.e., powder mixture) prior to the agglomerating step. In other embodiments, the method comprises a step of adding lecithin onto the formed agglomerates comprising whole grains. The lecithin may be applied, for example, using a lecithin spray system. During test runs, the applying of lecithin was performed at temperatures of between about 38° C. (100.4° F.) to about 42° C. (107.6° F.) for about 20 ml/min (pilot scale). Agglomeration was achieved using a continuous ICF & Welko SPA laboratory instantizer model Pilot RC-R at pressures of about 0.8-2.0 bar and a temperature of about 25°-80° C. The dry blend was introduced at a feed rate of about 80-160 g/min (pilot scale) for agglomeration times of between about 30 seconds to about 1 minute.

Prior to the agglomerating step, the dry components should comprise particle sizes of less than or equal to about 200 μm. Thus, in all embodiments, the dry components comprise particles sizes of no more than about 200 μm. When the dry blend comprises at least one component comprising a particle size greater than about 200 μm, the method comprises a milling step for milling the dry components of the dry blend prior to the agglomerating step.

Ready-to-drink milk-based beverage products may comprise an amount of the agglomerates described herein ranging from between about 6% to about 33% agglomerates, based on the total weight of the ready-to-drink milk-based beverage product. Such amounts provide for a good source of complete protein to consumers. In some embodiments, ready-to-drink milk-based beverage products may comprise from between about 1% to about 26% whole grains. In some embodiments, the viscosity of ready-to-drink milk-based beverage products comprising the agglomerates described herein my range from about 10 cP to about 1,000 cP, depending on the amount of oats in the agglomerates.

### EXAMPLE(S)

The agglomerates described herein are now further detailed with reference to the following example formulations. These examples are provided for the purpose of illustration only and the embodiments described herein should in no way be construed as being limited to these examples. Rather, the embodiments should be construed to encompass any and all variations, which become evident as a result of the teaching provided herein. All values are approximate and should be interpreted as if preceded by the word “about.”

TABLE 1
Example Formulations

| Component | Sample 1 | Sample 2 | Sample 3 |
|---|---|---|---|
| Whole Oat Flour | 20% | 50% | 80% |
| Sweetening | 43% | 44% | 17.2% |
| Component | | | |
| Cocoa | 25% | 0 | 0 |
| Soy Lecithin | 1.5% | 0 | 0 |
| Polydextrose | 9.1% | 0.9% | 1% |
| Vitamins | 0.1% | 0.09% | 0.1% |
| Xantham | 0.8% | 1% | 1.2% |
| Flavors | 0.5% | 4% | 0.5% |

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The agglomerates and methods disclosed herein may be suitably practiced in the absence of any element, limitation, or step that is not specifically disclosed herein. Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. Agglomerates comprising:
non-hydrolyzed, substantially non-gelatinized whole grains in an amount of up to about 80%;
up to about 40% dry fruit;
between about 0.1% to about 2% hydrocolloids;
up to about 12.5% fiber;
up to about 3.75% beta-glucan;
up to about 45% sweetening component;
up to about 2% lecithin; and
up to about 25% cocoa;
said agglomerates comprising a moisture content of up to about 7%.

2. The agglomerates of claim 1 comprising a minimum of about 20% non-hydrolyzed, substantially non-gelatinized whole grains.

3. The agglomerates of claim 1 comprising a particle size distribution of between about 70% to about 90% of particles sized from between about 100 to 1,000 μm.

4. The agglomerates of claim 1 where the non-hydrolyzed, substantially non-gelatinized whole grains comprise oat, wheat corn, rice, barley, millet, sorghum, rye, triticale, amaranth, quinoa, linseed, chia, or any combination thereof.

5. The agglomerates of claim 1 wherein the non-hydrolyzed, substantially non-gelatinized whole grains comprise a whole grain flour.

6. The agglomerates of claim 5 wherein the whole grain flour consists of oat flour.

7. The agglomerates of claim 1 comprising a wettability of no more than about 300 seconds.

8. The agglomerates of claim 1 wherein the sweetening component comprises a nutritive sweetener, a non-nutritive sweetener, or a combination thereof.

9. The agglomerates of claim 1 wherein the sweetening component comprises up to 45% nutritive sweetener.

10. The agglomerates of claim 1 comprising between about 5% and about 25% cocoa.

11. The agglomerates of claim 10 comprising between about 0.5% to about 2% lecithin.

12. The agglomerates of claim 1 free of cocoa.

13. The agglomerates of claim 1 comprising a bulk density of between about 0.3 g/mL to about 0.6 g/mL.

14. The agglomerates of claim 1 comprising a substantially spherical shape with porosity.

15. A method of producing a porous agglomerate capable of disbursing into a liquid, the method comprising the steps of:
forming a homogenous dry blend comprising non-hydrolyzed, substantially non-gelatinized whole grains in an amount of up to 80%, the dry blend comprising components of no more than about 200 μm;
agglomerating the dry blend to form whole grain agglomerates.

16. The method of claim 15 wherein the non-hydrolyzed, substantially non-gelatinized whole grains comprise oat, wheat corn, rice, barley, millet, sorghum, rye, triticale, amaranth, quinoa, linseed, chia, or any combination thereof.

17. The method of claim 15 wherein the dry blend comprises cocoa and further wherein the method comprises a separate step of applying lecithin.

18. The method of claim 17 wherein the applying lecithin is performed after forming the dry blend and before the agglomerating step.

19. The method of claim 17 wherein the step of applying lecithin is performed after the agglomerating step wherein the lecithin is applied to the whole grain agglomerates.

20. The method of claim 15 further comprising a step of milling dry components comprising a size of more than about 200 μm prior to the forming step.

21. A ready-to-drink milk-based beverage product comprising an amount of an agglomerated powder comprising between about 20% to about 80% non-hydrolyzed, substantially non-gelatinized whole grains, wherein the amount of agglomerated powder is from about 6% to about 33% based on total weight of the ready-to-drink milk-based beverage product.

22. The ready-to-drink milk-based beverage product of claim 21 comprising between about 1% to about 26% of said whole grains.

23. The ready-to-drink milk-based beverage produce of claim 21 comprising a viscosity ranging from about 10 cP to about 1,000 cP.
